(19) United States
(12) Patent Application Publication
(10) Pub. No.: US 2018/0262457 A1
(43) Pub. Date: Sep. 13, 2018

(54) SELF-DEBUGGING OF ELECTRONIC MESSAGE BUGS

(71) Applicant: Microsoft Technology Licensing, LLC, Redmond, WA (US)

(72) Inventors: Chetan Bansal, Seattle, WA (US); Mark Encarnacion, Bellevue, WA (US); Patrick Pantel, Bellevue, WA (US); Woon Kiat Wong, Redmond, WA (US)

(21) Appl. No.: 15/455,061

(22) Filed: Mar. 9, 2017

(51) Int. Cl. H04L 12/58; H04L 29/06

(52) U.S. Cl. CPC H04L 51/30; H04L 63/1441; H04L 51/10; H04L 51/18

(57) ABSTRACT

Electronic messages are automatically debugged. An electronic message sent by a sender to one or more recipients is received and analyzed to identify any issues in the message. Whenever one or more issues are identified in the message, a reply message may be sent to the sender that describes each of the identified issues and includes a proposed fix for each of the identified issues. Each of the issues identified in the message may also be fixed resulting in a fixed version of the message, and the fixed version of the message may be sent to the sender for their approval. The fixed version of the message may also be sent to each of the recipients. Whenever no issues are identified in the message, a reply message may be sent to the sender informing them that no issues were found.

### BACKGROUND

The Internet is a global data communications system that serves billions of people across the globe and provides them access to a vast array of online information resources and services including those provided by the World Wide Web and intranet-based enterprises. Thanks to the ubiquity of the Internet and the wide variety of network-enabled end-user computing devices that exist today, many of which are mobile computing devices, people today spend a large and ever-increasing amount of time performing a wide variety of tasks and activities online (e.g., using various types of end-user computing devices that are configured to operate over a data communication network such as the Internet, among other types of networks). For example, many people today heavily rely on electronic messages to communicate with each other in both a professional and a personal context. As such, electronic messages have become an integral part of daily life for many people today.

### SUMMARY

Message debugging technique implementations described herein generally provide for the automatic debugging of electronic messages. In one exemplary implementation an electronic message sent by a sender to one or more recipients is received. The message is then analyzed to identify any issues in the message. Whenever one or more issues are identified in the message, a reply message is sent to the sender that includes a proposed fix for each of the issues identified in the message. In another exemplary implementation, whenever one or more issues are identified in the message, each of the issues identified in the message is fixed, where this fixing results in a fixed version of the message, and the fixed version of the message is sent to the sender for their approval. In yet another implementation, the fixed version of the message is sent to each of the recipients.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the message debugging technique implementations described herein will become better understood with regard to the following description, appended claims, and accompanying drawings where:

FIG. 1 is a diagram illustrating an exemplary implementation, in simplified form, of a system framework for realizing the message debugging technique implementations described herein.

FIGS. 2 and 3 are flow diagram illustrating one implementation, in simplified form, of a process for debugging electronic messages.

FIG. 4 is a flow diagram illustrating another implementation, in simplified form, of a process for debugging electronic messages.

FIG. 5 is a diagram illustrating an exemplary implementation, in simplified form, of a message validator computer program.

FIG. 6 is a diagram illustrating a simplified example of a general-purpose computer system on which various implementations and elements of the message debugging technique, as described herein, may be realized.

### DETAILED DESCRIPTION

In the following description of message debugging technique implementations reference is made to the accompanying drawings which form a part hereof, and in which are shown, by way of illustration, specific implementations in which the message debugging technique can be practiced. It is understood that other implementations can be utilized and structural changes can be made without departing from the scope of the message debugging technique implementations.

It is also noted that for the sake of clarity specific terminology will be resorted to in describing the message debugging technique implementations described herein and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation”, or “one version”, or “another version”, or an “exemplary version”, or an “alternate version”, or “one variant”, or “another variant”, or an “exemplary variant”, or an “alternate variant” means that a particular feature, a particular structure, or particular characteristics described in connection with the implementation/version/variant can be included in at least one implementation of the message debugging technique. The appearances of the phrases “in one implementation”, “in another implementation”, “in an exemplary implementation”, “in an alternate implementation”, “in one version”, “in another version”, “in an exemplary version”, “in an alternate version”, “in one variant”, “in another variant”, “in an exemplary variant”, and “in an alternate variant” in various places in the specification are not necessarily all referring to the same implementation/version/variant, nor are separate or alternative implementations/versions/variants mutually exclusive of other implementations/versions/variants. Yet furthermore, the order of process flow representing one or more implementations, or versions, or variants of the message debugging technique does not inherently indicate any particular order nor imply any limitations of the message debugging technique.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive, in a manner similar to the term “comprising”, as an open transition word without precluding any additional or other elements.

### 1.0 Electronic Messages and Electronic Messaging Systems

As described heretofore, electronic messages have become an integral part of daily life for many people today, where these messages involve both professional and personal communication. For example, it is estimated that as of 2015 over 4 billion email (also known as electronic mail and e-mail) accounts exist within the Internet. In addition to professional and personal communication, email is also used for a wide variety of other tasks and activities such as professional and personal time management (e.g., scheduling and task planning), and professional and personal file management, among other tasks and activities. As such, email represents one of the largest sources of user-generated electronic (e.g., digital) content today. Similarly, millions of instant text messages (also known as SMS (Short Message Service) messages), instant multimedia messages (also known as MMS (Multimedia Messaging Service) messages), and online chat messages (also known as instant messaging (IM) messages, among other things) per second are also sent over one or more data communication networks, where these messages also involve both professional and personal communication.

The term “electronic message” is used herein to refer to a digital message that is communicated between a sender and one or more recipients over one or more conventional data communication networks. The term “sender” is used herein to refer to a person who or system that generates an electronic message that is addressed to and subsequently sent to one or more recipients. Correspondingly, the term “recipient” is used herein to refer to a person or group of people who, or a system that, receives an electronic message that is sent to them by a sender. As will be described in more detail hereafter, the message debugging technique implementations described herein are operable with various types of electronic messages including, but not limited to email messages, instant text messages, instant multimedia message, and online chat messages.

Today's electronic messaging systems are generally server-based and operate in a store and forward model where message servers accept, forward, deliver and store electronic messages that are sent from senders to recipients. As such, today's electronic messaging systems generally operate in a client/server manner where senders and recipients can use a wide variety of conventional client applications to both send and receive electronic messages, where these client applications are operational on a wide variety of both mobile and non-mobile computing devices examples of which are described in more detail hereafter. For example, in the case of email messages these messages are exchanged between email servers using conventional protocols (e.g., SMTP (the Simple Mail Transfer Protocol)). Recipients can retrieve any email messages that are sent to them using conventional protocols such as POP (Post Office Protocol) and IMAP (Internet Message Access Protocol), among others. Senders and recipients can also use conventional web-based applications to both send and receive electronic messages via a conventional web browser running on a conventional mobile or non-mobile computing device.

As today's electronic messaging systems evolve new capabilities are being added to these systems in order to make electronic message communication between people, and systems and people, easier, more intelligent, and more efficient. For example, in addition to supporting the use of plain text content in the body of an electronic message, electronic messaging systems today may also support the use of markup-language-based content in the body of an electronic message. As is appreciated in the arts of computing and the World Wide Web (herein sometimes simply referred to as the web), various conventional markup languages exist that provide a system for annotating a document or message in a way that is syntactically distinguishable from the text of the document/message, where these annotations are generally implemented using tags that are embedded within the document/message (or more particularly, instruction text that is encapsulated by tags)—each of these annotations is hereafter referred to as a markup. Each markup that is embedded within a document/message instructs the software that displays the document/message to carry out one or more specific actions that are associated with the markup when displaying the document/message. As such, a person who is viewing the displayed document/message does not see the markup itself, but rather sees the effect of the one or more specific actions that are associated with the markup.

As is also appreciated in the arts of computing and the World Wide Web, one popular markup language is HTML (HyperText Markup Language) which is understood by all modern messaging clients, and thus is widely used throughout the web and its myriad of content. The use of HTML content in the body of an electronic message advantageously allows various types of content to be embedded within the body of the message—examples of these content types include images, audio, video and URL (Uniform Resource Locator) links to specific web pages and other types of web-based content, among other types of content. Using HTML content in the body of an electronic message also advantageously allows emphasis such as underlines, italics, bolded text, highlighted text, different-colored text, and different font styles to be employed in the message—such emphasis can make it easier for the sender to communicate their message to each recipient, and can also result in a more effective and efficient communication of the message.

The ability for a sender to embed one or more markups within the body of an electronic message that the sender generates and subsequently sends to one or more recipients can also provide each of the recipients with a rich set of user experiences that are semantically related to the message itself and increase user efficiency. For example, in the case where the sender is an airline or hotel company, the recipient is a person who makes a flight/hotel reservation with the airline/hotel company, and the sender wants to send an electronic message to the recipient confirming the flight/hotel reservation they just made, the sender can embed a markup in the body of the message indicating that its a flight/hotel reservation confirmation. This enables the electronic messaging system that receives the electronic message to automatically identify it as a flight/hotel reservation confirmation, automatically extract the details of the reservation from the message, and then automatically add the details of the reservation to the recipient's calendar and create alerts for the recipient. The electronic messaging system can also collect all of the electronic messages that are related to this reservation together into what is sometimes referred to as a “bundle”. In the case where the sender is an employee of a company, the recipient is a manager in the company whom the sender reports to, and the sender wants to send their recent expense report via an electronic message to the recipient for the recipient's approval, the sender can embed a markup in the body of the message resulting in a user-selectable item (e.g., an “Approve” link or button) which the recipient can select (e.g., click on or touch) to indicate their approval of the expense report. The sender can also embed another markup in the body of the electronic message resulting in another user-selectable item (e.g., an “View Expense Report Details” link) which the recipient can select to review the details of the expense report before they approve it. This ability to embed the just described exemplary types of markups in the body of an electronic message allows the recipient(s) to complete any needed action(s) on the message (e.g., a task(s) that is related to or requested in the message) from within whatever client application the recipient(s) is using to view the message. In other words, the recipient(s) can complete the needed action/task without having to switch to another application, thus saving the recipient(s) time and improving their efficiency.

Electronic messages which contain markups providing for user-selectable actions are hereafter sometimes referred to as actionable electronic messages. It will be appreciated that a given actionable electronic message may rely upon one or more backend services (e.g., services which are external to the messaging system) to complete a given action/task that is embedded within the message.

### 2.0 Self-Debugging of Electronic Message Bugs

The message debugging technique implementations described herein generally provide for the automatic debugging of electronic messages. More particularly and as will be described in more detail hereafter, the message debugging technique implementations operate to automatically identify (e.g., detect) any issues (e.g., bugs) that may exist in a given electronic message. The message debugging technique implementations can then suggest (e.g., propose) a fix (e.g., a correction) for each issue that is identified in the electronic message. The message debugging technique implementations can also automatically fix (e.g., correct) each issue that is identified in the electronic message. As described heretofore, the message debugging technique implementations are operable with various types of electronic messages including, but not limited to email messages, instant text messages, instant multimedia messages, and online chat messages.

The message debugging technique implementations described herein are advantageous for various reasons including, but not limited to, the following. As will be appreciated from the foregoing and the more-detailed description that follows, the message debugging technique implementations enhance the electronic message experience of both senders and recipients by making electronic message communication between senders and recipients easier, more intelligent, and more efficient. The message debugging technique implementations thus increase user efficiency and satisfaction associated with sending and receiving electronic messages. More particularly and as is appreciated in the art of electronic messaging, successful communication of a given electronic message from a sender to one or more recipients is contingent on many different properties of the message itself and the system being used to communicate the message such as the particular sender and recipients, the particular type of application the sender uses to generate and send the message, the particular type of application each of the recipients will be using to open and read the message, and various other aspects of the content that the sender includes in the body of the message (e.g., any markups that are embedded in the message body, keywords that appear in the message body, the formatting of the message body, or the like), among other electronic message and system properties.

As will also be appreciated from the more-detailed description that follows, the message debugging technique implementations eliminate the need for both the sender and the recipient(s) to have to manually debug a given electronic message and the system that is being used to communicate the message when an issue(s) (e.g., bug(s)) exists in the message that is preventing it from being successfully delivered to, or interpreted by and acted upon, by the recipient(s). Given the complex nature of today's electronic messaging systems and the fact that these systems are often proprietary, it will be appreciated that such manual debugging can be technically complex and very time consuming, and may require advanced knowledge or tools that the sender and recipient(s) likely do not have. The message debugging technique implementations provide a seamless way for today's electronic messaging systems to allow issues in the electronic messages that are communicated through these systems to be resolved without having to expose any proprietary information about the system design and architecture.

The message debugging technique implementations may also be employed by various types of electronic messaging systems and services including, but not limited to, email systems/services, instant text and multimedia message systems/services, and online chat systems/services. The message debugging technique implementations may also be employed by various types of productivity applications such as OFFICE 365® (a registered trademark of Microsoft Corporation) and DYNAMICS™ (a trademark of Microsoft Corporation) 365, among others.

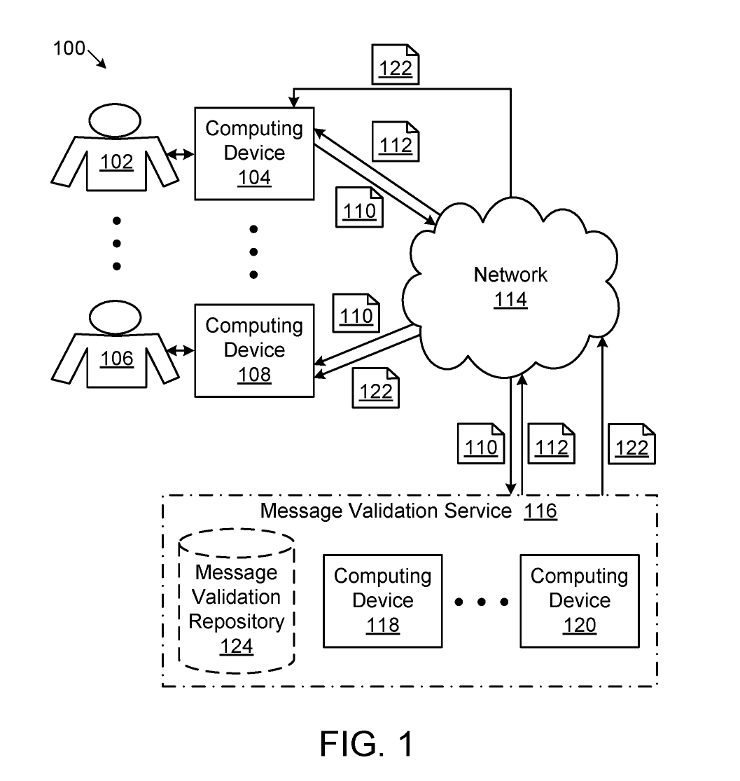

FIG. 1 illustrates an exemplary implementation, in simplified form, of a system framework for realizing the message debugging technique implementations described herein. As exemplified in FIG. 1 the system framework 100 includes a plurality of end-user computing devices 104/108 each of which is configured to communicate various types of information over a conventional data communication network 114 (herein also referred to as a computer network) such as the Internet (among other types of conventional data communication networks). Each of the computing devices 104/108 can be any type of conventional mobile computing device such as a smartphone, or a tablet computer, or a laptop computer (sometimes also referred to as a notebook or netbook computer), or a computing device that is integrated into an automobile (e.g., a car, or a truck, or any other type of motorized vehicle), among other types of conventional mobile computing devices. Each of the computing devices 104/108 can also be any type of conventional non-mobile computing device such as a desktop personal computer (PC), or a video game console, among other types of conventional non-mobile computing devices.

Referring again to FIG. 1, a sender 102 may utilize their end-user computing device 104 to send an electronic message 110 over the data communication network 114 to one or more recipients (e.g., recipient 106). Each of the end-user computing devices 104/108 is also configured to communicate over the network 114 with a message validation service 116 that runs on one or more other computing devices 118/120. These other computing devices 118/120 can also communicate with each other via the network 114. In an exemplary implementation of the message debugging technique described herein the other computing devices 118/120 are located in the cloud so that the message validation service 116 operates as a cloud service and the network 114 includes wide area network functionality. The term “cloud service” is used herein to refer to a web application that operates in the cloud and can be hosted on (e.g., deployed at) a plurality of data centers that can be located in different geographic regions (e.g., different regions of the world).

Referring again to FIG. 1 and as will be described in more detail hereafter, the message validation service 116 generally performs a variety of functions associated with debugging electronic messages such as the electronic message 110 that is sent by the sender 102 to one or more recipients 106. By way of example but not limitation, in one implementation of the message debugging technique described herein the message validation service 116 receives the message 110 and then analyzes the message 110 to identify any issues that may exist in the message 110. Then, whenever one or more issues are identified (e.g., detected) in the message 110, the message validation service 116 will send a reply message 112 to the sender 102, where the message 112 describes each of the identified issues and includes a proposed fix for each of the identified issues, and the message 112 may also ask the sender 102 to approve of each of these proposed fixes. Exemplary types of issues that can be identified by the message validation service 116 and proposed fixes for each type of issue are described in more detail hereafter. In the case where the sender 102 implements the proposed fixes on their own and sends an updated version of the electronic message 110, this updated version will again be received and analyzed by the message validation service 116. In the case where the reply message 112 asks the sender 102 to approve of each of the proposed fixes, upon the message validation service 116 receiving input from the sender 102 indicating that they approve of each of the proposed fixes, the service 116 will implement the proposed fix for each of the issues identified in the message 110 resulting in a fixed version of the electronic message 122, and the service 116 will then send this fixed version of the message 122 to each of the recipients 106. Whenever no issues are identified in the message 110, the message validation service 116 can send the message 110 to each of the recipients 106, and can also send a message (not shown) to the sender 102 informing them that no issues were found in their message 110.

Referring again to FIG. 1 and as will also be described in more detail hereafter, in another implementation of the message debugging technique described herein, whenever the message validation service 116 identifies one or more issues in the electronic message 110 that is sent by the sender 102 to one or more recipients 106, the service 116 will fix each of the issues that is identified in the message 110 resulting in the aforementioned fixed version of the electronic message 122, and the service 116 will then send this fixed version of the message 122 to the sender 102 for their approval. Upon the message validation service 116 receiving input from the sender 102 indicating that they approve of the fixed version of the electronic message 122, the service 116 will send this fixed version of the message 122 to each of the recipients 106. In yet another implementation of the message debugging technique, whenever the message validation service 116 identifies one or more issues in the electronic message 110, the service 116 will automatically fix each of the issues that is identified in the message 110 resulting in the aforementioned fixed version of the electronic message 122, and the service 116 will then send this fixed version of the message 122 to each of the recipients 106.

Referring again to FIG. 1, the system framework 100 can optionally also include a dedicated message validation repository 124 that is accessible by the other computing devices 118/120 and is used to store the electronic message 110 that is sent by the sender 102 to the recipients 106. In an exemplary implementation of the message debugging technique described herein where the message 110 is an email message, this repository 124 is realized as a validation mailbox having a specific email address (e.g., messagedebug@contoso.com) that is known by the sender and is whitelisted (e.g., allowed) by the email server that receives each email message that is sent by the sender 102. The sender 102 can send a desired email message to the specific email address associated with the validation mailbox in order to determine if there are any issues with this email message. Upon the email message being received by the validation mailbox, the message validation service 116 can analyze the email message and provide the sender with the validation results. In the case where the message validation service 116 identifies one or more issues in the email message, the service 116 can send a reply message to the sender 102 listing each of identified issues along with a proposed fix therefore as applicable—the service 116 can also fix each of the identified issues resulting in a fixed version of the email message, and can then send this fixed version to the sender for their approval. In the case where the message validation service 116 determines that there are no issues in the email message, the service can send a reply message to the sender informing them of this determination. As such, the just-described validation mailbox may be used as a self-service mailbox for validating electronic messages.

As will be appreciated from the more-detailed description that follows, the types of issues that are detected in a given electronic message depend on various factors such as the content of the message, the particular sender of the message, and the particular recipient(s) of the message, among other factors. It is noted that the message debugging technique implementations described herein can identify a wide variety of issues that may exist in a given electronic message. The message debugging technique implementations can then propose fixes for, and/or automatically implement fixes for each issue that is identified in the electronic message. Examples of such issues that can be identified and fixed are described in more detail hereafter. It is also noted that the types of issues described hereafter are exemplary, and the message debugging technique implementations can also identify and fix other types of issues not mentioned herein that may exist in a given electronic message.

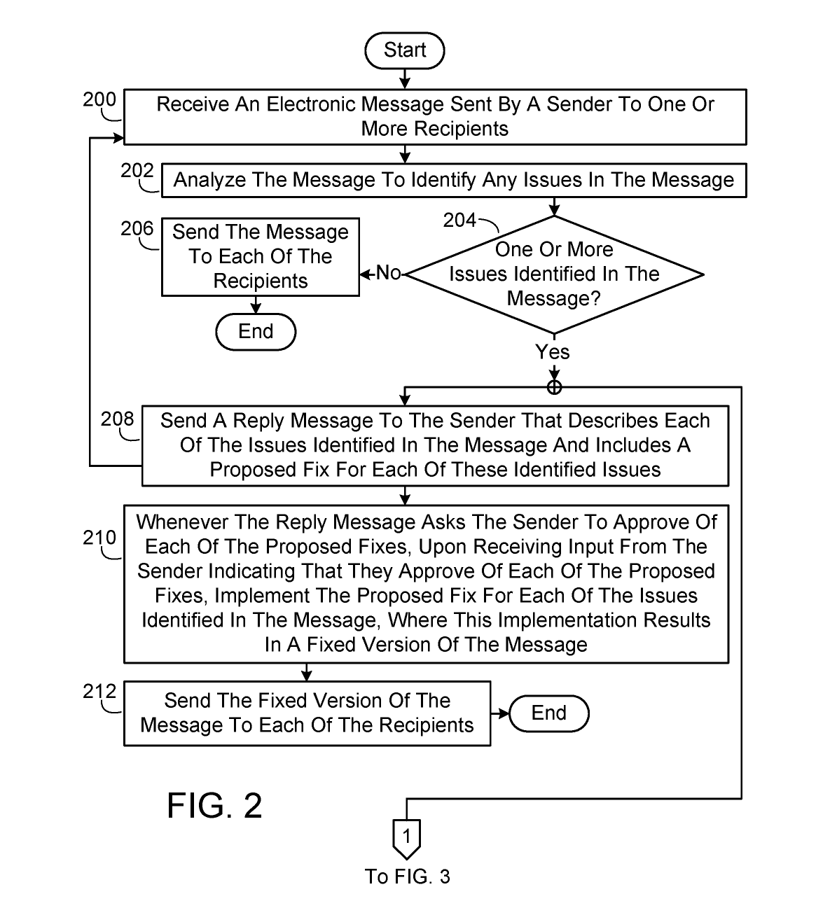

FIGS. 2 and 3 illustrate one implementation, in simplified form, of a process for debugging electronic messages. In an exemplary implementation of the message debugging technique described herein the process illustrated in FIGS. 2 and 3 is realized on the system framework 100 illustrated in FIG. 1. As exemplified in FIG. 2 the process starts with receiving an electronic message that is sent by a sender to one or more recipients (process action 200). The electronic message is then analyzed to identify any issues that may exist in the electronic message (process action 202). Exemplary types of electronic messages that can be received (action 200) and analyzed (action 202) have been described heretofore. Whenever no issues are identified in the electronic message (process action 204, No), the electronic message is sent to each of the recipients (process action 206), and a reply message may also be sent to the sender informing them that no issues were identified in their message. Whenever one or more issues are identified in the electronic message (process action 204, Yes), the following actions may occur. In one implementation of the message debugging technique a reply message is sent to the sender, where this reply message describes each of the issues that is identified in the electronic message and includes a proposed fix for each of these identified issues (process action 208). The sender may then implement the proposed fixes and send an updated version of the electronic message which will again be received (action 200) and analyzed (action 202). Given the foregoing and the more-detailed description that follows, it will be appreciated that the combination of actions 202, 204 and 208 has the advantageous effect of increasing the efficiency and productivity, and thus the satisfaction, of the sender. In another implementation of the message debugging technique the reply message that is sent to the sender in action 208 can also ask the sender to approve of each of the proposed fixes. Upon receiving input from the sender indicating that they approve of each of the proposed fixes, the proposed fix for each of the issues identified in the electronic message is implemented, where this implementation results in a fixed version of the electronic message (process action 210). The fixed version of the electronic message is then sent to each of the recipients (process action 212).

Referring again to FIG. 2, in the case where the issues identified in the electronic message (action 202) include a missing markup in the body of the electronic message, the proposed fix (action 208) for this missing markup would be to add the missing markup to the body of the message. Correspondingly, action 210 could automatically add the missing markup to the body of the electronic message. In the case where one or more markups are embedded within the body of the electronic message, and the issues identified in the electronic message include one of these markups being malformed, the proposed fix for one of the markups being malformed would be to correct the malformed one of the markups in the body of the message. Correspondingly, action 210 could automatically correct the malformed one of the markups in the body of the electronic message. In the case where one or more user-selectable links (e.g., URLs) are embedded within the body of the electronic message, and the issues identified in the electronic message include one of these user-selectable links being blocked by the electronic messaging system that is being used to communicate the electronic message to the recipients, the proposed fix for one of the user-selectable links being blocked may include removing the blocked one of the user-selectable links from the body of the message. Correspondingly, action 210 could automatically remove the blocked one of the user-selectable links from the body of the electronic message. The proposed fix for one of the user-selectable links being blocked may also include requesting that the blocked one of the user-selectable links be unblocked. In the case where one or more user-selectable links are embedded within the body of the electronic message, and the issues identified in the electronic message include one of these user-selectable links being known to be malicious, the proposed fix for one of the user-selectable links being known to be malicious includes removing the malicious one of the user-selectable links from the body of the message. Correspondingly, action 210 could automatically remove the malicious one of the user-selectable links from the body of the message.

As is appreciated in the art of electronic messaging, different features that may be included in a given electronic message can have different system requirements. By way of example but not limitation, a recipient of an actionable electronic message that includes markups providing for a given user-selectable action may need to be running a specific client application or a specific version thereof in order for the recipient to be able to successfully complete the user-selectable action; one or more specific backend services may also need to be available to the recipient's client application in order for the recipient to be able to successfully complete the user-selectable action. Referring again to FIG. 2, in the case where one or more markups providing for a user-selectable action are embedded within the body of the electronic message (e.g., the message is an actionable electronic message), and the issues identified in the electronic message (action 202) include either client support for user-selectable action being unavailable, or backend support for the user-selectable action being unavailable or deprecated, or a combination thereof, the proposed fix (action 208) for these particular issues would be to remove the markups providing for the user-selectable action from the body of the message, thus removing the user-selectable action from the message.

Referring again to FIG. 2, in the case where the issues identified in the electronic message (action 202) include an illegal character being in the electronic message, the proposed fix (action 208) for this illegal character includes removing the illegal character from the message. Correspondingly, action 210 could automatically remove the illegal character from the electronic message. It is noted that the just-described illegal character may be present anywhere in the electronic message, such as the body of the message, or the subject line of the message, among other parts of the message. An exemplary illegal character scenario is the following. In the aforementioned case where one or more markups are embedded within the body of the electronic message, the electronic messaging system that is being used to communicate the electronic message to the recipients may dictate that no HTML tags may be embedded in any of the markups—in this situation an HTML tag that is embedded in a given markup within the body of the electronic message would be considered to be an illegal markup in action 202. Another exemplary illegal character scenario is the following scenario that involves the character encoding that is employed in the electronic message. More particularly, the messaging system may expect the electronic message to employ the conventional Unicode character encoding. However, the electronic message may instead employ a character encoding other than Unicode (e.g., the conventional UTF-8 (Unicode Transformation Format 8) character encoding). In this situation action 210 could automatically transform the character encoding employed in the body of the electronic message to an encoding type that the messaging system expects to see (e.g., action 210 could transform the UTF-8 character encoding to the Unicode character encoding).

Referring again to FIG. 2, in the case where the issues identified in the electronic message (action 202) include an invalid content type being in the body of the electronic message, the proposed fix (action 208) for this invalid content type includes changing the invalid content type to another content type which is valid. As is appreciated in the art of electronic messaging and as described heretofore, a given electronic message can have various types of content (e.g., plain text content and HTML content, among other content types) and a given electronic messaging system that is used to communicate the electronic message may be configured to allow certain specific types of content and not allow other types of content. In an exemplary case where the messaging system is configured to allow just plain text content in the body of the messages that are communicated by the messaging system, and the body of the message that is sent by the sender includes HTML content, action 202 would identify the HTML content to be invalid; action 208 would then report this issue to the sender and may recommend to the sender that they change the HTML content to plain text content for compatibility with the messaging system. In the case where a declaration of allowed content types is missing in (e.g., not specified by) the messaging system, action 210 could automatically add the missing allowed content types declaration to the messaging system, where this declaration could include the content type(s) identified in the body of the electronic message.

Referring again to FIG. 2, in the case where the issues identified in the electronic message (action 202) include the sender being unallowed (e.g., not whitelisted—not on the list of allowed senders—not on the senders whitelist) by the electronic messaging system that is being used to communicate the electronic message to the recipients, action 210 could automatically add the sender to the messaging system's list of allowed senders (e.g., add the sender to the senders whitelist).

Referring again to FIG. 2 and as exemplified in FIG. 3, in another implementation of the message debugging technique described herein, whenever one or more issues are identified in the electronic message (action 204, Yes), each of the issues that is identified in the electronic message is fixed, where this fixing results in a fixed version of the electronic message (process action 300), and this fixed version of the electronic message is then sent to the sender for their approval (process action 302). Then, upon receiving input from the sender indicating that they approve of the fixed version of the electronic message, the fixed version of the electronic message is sent to each of the recipients (process action 304). Given the foregoing, it will be appreciated that the combination of actions 202, 204, 300 and 302 has the advantageous effect of increasing the efficiency and productivity, and thus the satisfaction, of the sender.

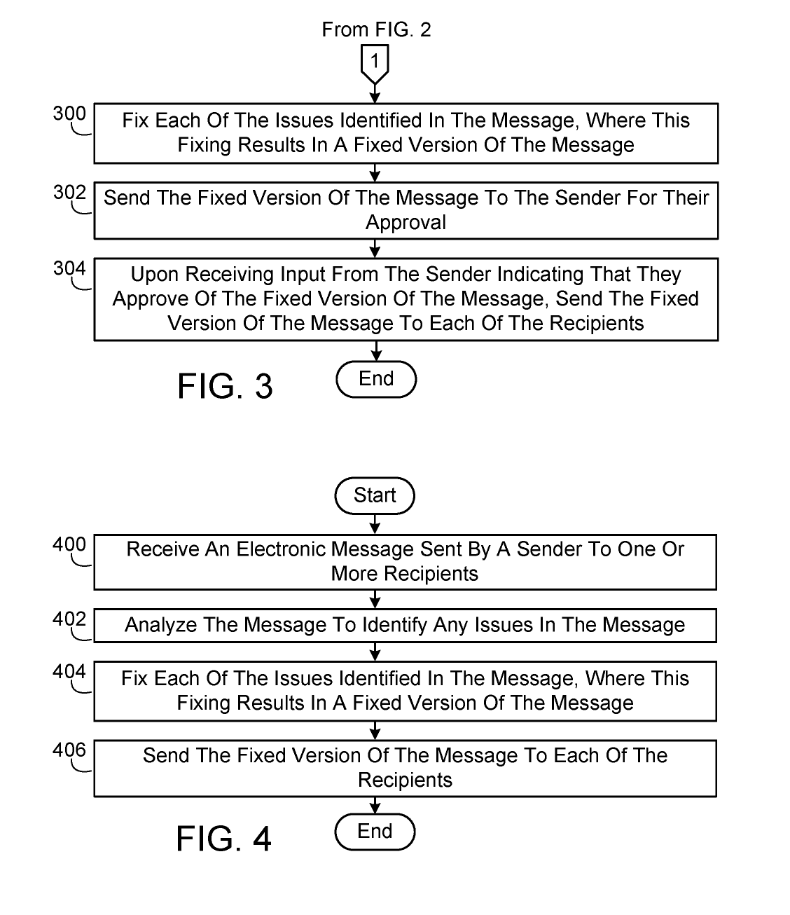

FIG. 4 illustrates another implementation, in simplified form, of a process for debugging electronic messages. In an exemplary implementation of the message debugging technique described herein the process illustrated in FIG. 4 is realized on the system framework 100 illustrated in FIG. 1. As exemplified in FIG. 4 the process starts with receiving an electronic message that is sent by a sender to one or more recipients (process action 400). The electronic message is then analyzed to identify any issues that may exist in the electronic message (process action 402). Exemplary types of electronic messages that can be received (action 400) and analyzed (action 402) have been described heretofore. Each of the issues that is identified in the electronic message is then fixed, where this fixing resulting in a fixed version of the electronic message (process action 404). The fixed version of the electronic message is then sent to each of the recipients (process action 406). Given the foregoing, it will be appreciated that the combination of actions 402 and 404 has the advantageous effect of increasing the efficiency and productivity, and thus the satisfaction, of the sender.

Referring again to FIGS. 2 and 4, in an exemplary implementation of the message debugging technique described herein the action of analyzing the electronic message to identify any issues in the electronic message (actions 202 and 402) is realized by using a validation engine to process the electronic message, where this engine employs a prescribed set of rules and patterns to perform the issues identification. This particular implementation is hereafter referred to as the rules and patterns implementation. It will be appreciated that the set of rules and patterns that is employed by the validation engine defines the different types of issues that can be identified in the electronic message that is sent by the sender. Many different types of rules and patterns may be employed by the validation engine, some examples of which will now be described in more detail. In one version of the rules and patterns implementation the validation engine checks the electronic message to see if valid DKIM (DomainKeys Identified Mail) and SPF (Sender Policy Framework) headers are present. In another version of the rules and patterns implementation the validation engine checks the electronic message to see if it contains any broken links or images. In another version of the rules and patterns implementation the validation engine checks to see if the sender is whitelisted. In another version of the rules and patterns implementation the validation engine checks the electronic message to see if it contains any markups, and checks each markup to see if it contains valid JSON (JavaScript Object Notation) and a valid markdown; the validation engine may also use REGEX (regular expression) patterns to verify that the markup does not contain HTML. In another version of the rules and patterns implementation the validation engine checks the electronic message to see if the sender is allowed to send marked-up messages. In another version of the rules and patterns implementation the validation engine checks the electronic message to see if it is an actionable message, then checks each of the actions embedded in the message to see if the action employs an action endpoint to complete the action, and then checks to see if the action endpoint is whitelisted. As is appreciated in the art of electronic messaging, a given electronic messaging system generally maintains two different whitelists, one of which lists the addresses of the allowed senders, and the other of which lists the allowed action endpoints that may be employed to complete the actions that may be embedded in a given electronic message.

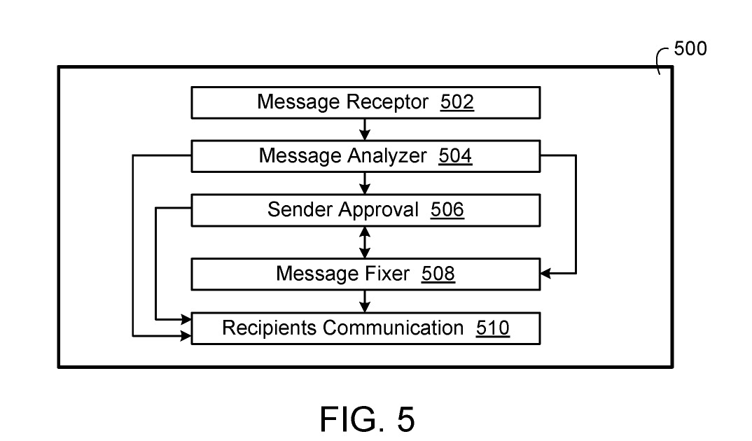

FIG. 5 illustrates an exemplary implementation, in simplified form, of a message validator computer program. As exemplified in FIG. 5 and referring again to FIGS. 2-4, the message validator computer program 500 includes, but is not limited to, a message receptor sub-program 502 that performs actions 200 and 400, a message analyzer sub-program 504 that performs actions 202, 204 and 402, a sender approval sub-program 506 that performs actions 208 and 302, a message fixer sub-program 508 that performs actions 210, 300 and 404, and a recipients communication sub-program 510 that performs actions 206, 212, 304 and 406. Each of the just-described sub-programs is realized on a computing device such as that which is described in more detail in the Exemplary Operating Environments section which follows. More particularly and by way of example but not limitation, and referring again to FIG. 1, in an exemplary implementation of the message debugging technique described herein the just-described sub-programs may be realized on the computing devices 118/120.

### 3.0 Other Implementations

While the message debugging technique has been described by specific reference to implementations thereof, it is understood that variations and modifications thereof can be made without departing from the true spirit and scope of the message debugging technique. It is noted that any or all of the implementations that are described in the present document and any or all of the implementations that are illustrated in the accompanying drawings may be used and thus claimed in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 4.0 Exemplary Operating Environments

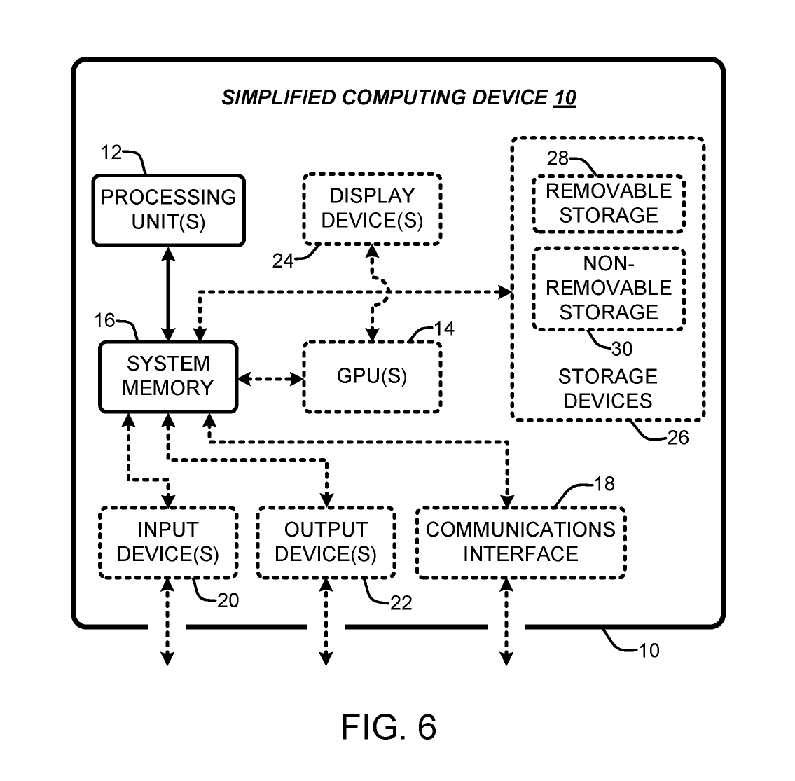

The message debugging technique implementations described herein are operational within numerous types of general purpose or special purpose computing system environments or configurations. FIG. 6 illustrates a simplified example of a general-purpose computer system on which various implementations and elements of the message debugging technique, as described herein, may be implemented. It is noted that any boxes that are represented by broken or dashed lines in the simplified computing device 10 shown in FIG. 6 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the message debugging technique implementations described herein, the device should have a sufficient computational capability and system memory to enable basic computational operations. In particular, the computational capability of the simplified computing device 10 shown in FIG. 6 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of the message debugging technique implementations described herein, including input, output, control, feedback, and response to one or more users or other devices or systems associated with the message debugging technique implementations, are enabled by a variety of Natural User Interface (NUI) scenarios. The NUI techniques and scenarios enabled by the message debugging technique implementations include, but are not limited to, interface technologies that allow one or more users user to interact with the message debugging technique implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors (e.g., speech and/or voice recognition). Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the message debugging technique implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the message debugging technique implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 6 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, programs, sub-programs, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, programs, sub-programs, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, sub-programs, and/or computer program products embodying some or all of the various message debugging technique implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The message debugging technique implementations described herein may be further described in the general context of computer-executable instructions, such as programs, sub-programs, being executed by a computing device. Generally, sub-programs include routines, programs, objects, components, data structures, and the like, that perform particular tasks or implement particular abstract data types. The message debugging technique implementations may also be practiced in distributed computing environments where tasks are performed by one or more remote processing devices, or within a cloud of one or more devices, that are linked through one or more communications networks. In a distributed computing environment, sub-programs may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

Wherefore, what is claimed is:

1. A system for debugging electronic messages, comprising:
a message validator comprising one or more computing devices, said computing devices being in communication with each other via a computer network whenever there is a plurality of computing devices, and a computer program having a plurality of sub-programs executable by said computing devices, wherein the sub-programs configure said computing devices to,
receive an electronic message sent by a sender to one or more recipients,
analyze the electronic message to identify any issues in the electronic message, and
whenever one or more issues are identified in the electronic message, send a reply message to the sender comprising a proposed fix for each of the issues identified in the electronic message.

2. The system of claim 1, wherein the electronic message comprises one of:
an email message; or
an instant text message; or
an instant multimedia message; or
an online chat message.

3. The system of claim 1, wherein,
the issues identified in the electronic message comprise a missing markup in a body of the electronic message, and
the proposed fix for said missing markup comprises adding said missing markup to the body of the electronic message.

4. The system of claim 1, wherein,
one or more markups are embedded within a body of the electronic message,
the issues identified in the electronic message comprise one of said markups being malformed, and
the proposed fix for one of said markups being malformed comprises correcting the malformed one of said markups in the body of the electronic message.

5. The system of claim 1, wherein,
the issues identified in the electronic message comprise an illegal character being in the electronic message, and
the proposed fix for said illegal character comprises removing said illegal character from the electronic message.

6. The system of claim 1, wherein,
the issues identified in the electronic message comprise an invalid content type being in a body of the electronic message, and
the proposed fix for said invalid content type comprises changing said invalid content type to another content type which is valid.

7. The system of claim 1, wherein,
one or more user-selectable links are embedded within a body of the electronic message,
the issues identified in the electronic message comprise one of said user-selectable links being blocked, and
the proposed fix for one of said user-selectable links being blocked comprises one of removing the blocked one of said user-selectable links from the body of the electronic message, or requesting that the blocked one of said user-selectable links be unblocked.

8. The system of claim 1, wherein,
one or more user-selectable links are embedded within a body of the electronic message,
the issues identified in the electronic message comprise one of said user-selectable links being malicious, and
the proposed fix for one of said user-selectable links being malicious comprises removing the malicious one of said user-selectable links from the body of the electronic message.

9. The system of claim 1, wherein,
one or more markups providing for a user-selectable action are embedded within a body of the electronic message,
the issues identified in the electronic message comprise one or more of client support for said action being unavailable, or backend support for said action being unavailable or deprecated, and
the proposed fix for client support for said action being unavailable, or backend support for said action being unavailable or deprecated, comprises removing said markups from the body of the electronic message.

10. The system of claim 1, wherein the sub-programs further configure said computing devices to, whenever no issues are identified in the electronic message, send the electronic message to each of the recipients.

11. The system of claim 1, wherein the reply message asks the sender to approve of the proposed fix for each of the issues identified in the electronic message, and the sub-programs further configure said computing devices to, upon receiving input from the sender indicating that they approve of the proposed fix for each of the issues identified in the electronic message,
implement the proposed fix for each of the issues identified in the electronic message, said implementation resulting in a fixed version of the electronic message, and
send the fixed version of the electronic message to each of the recipients.

12. A system for debugging electronic messages, comprising:
a message validator comprising one or more computing devices, said computing devices being in communication with each other via a computer network whenever there is a plurality of computing devices, and a computer program having a plurality of sub-programs executable by said computing devices, wherein the sub-programs configure said computing devices to,
receive an electronic message sent by a sender to one or more recipients,
analyze the electronic message to identify any issues in the electronic message, and
whenever one or more issues are identified in the electronic message,
fix each of the issues identified in the electronic message, said fixing resulting in a fixed version of the electronic message, and
send the fixed version of the electronic message to the sender for their approval.

13. The system of claim 12, wherein,
the issues identified in the electronic message comprise a missing markup in a body of the electronic message, and
the sub-program for fixing each of the issues identified in the electronic message comprises a sub-program for adding said missing markup to the body of the electronic message.

14. The system of claim 12, wherein,
one or more markups are embedded within a body of the electronic message,
the issues identified in the electronic message comprise one of said markups being malformed, and
the sub-program for fixing each of the issues identified in the electronic message comprises a sub-program for correcting the malformed one of said markups in the body of the electronic message.

15. The system of claim 12, wherein,
the issues identified in the electronic message comprise an illegal character being in the electronic message, and
the sub-program for fixing each of the issues identified in the electronic message comprises a sub-program for removing said illegal character from the electronic message.

16. The system of claim 12, wherein,
one or more user-selectable links are embedded within a body of the electronic message,
the issues identified in the electronic message comprise one of said user-selectable links being blocked, and
the sub-program for fixing each of the issues identified in the electronic message comprises a sub-program for removing the blocked one of said user-selectable links from the body of the electronic message.

17. The system of claim 12, wherein,
one or more user-selectable links are embedded within a body of the electronic message,
the issues identified in the electronic message comprise one of said user-selectable links being malicious, and
the sub-program for fixing each of the issues identified in the electronic message comprises a sub-program for removing the malicious one of said user-selectable links from the body of the electronic message.

18. The system of claim 12, wherein,
the issues identified in the electronic message comprise the sender being unallowed, and
the sub-program for fixing each of the issues identified in the electronic message comprises a sub-program for adding the sender to a list of allowed senders.

19. The system of claim 12, wherein the sub-programs further configure said computing devices to, upon receiving input from the sender indicating that they approve of the fixed version of the electronic message, send the fixed version of the electronic message to each of the recipients.

20. A system for debugging electronic messages, comprising:
a message validator comprising one or more computing devices, said computing devices being in communication with each other via a computer network whenever there is a plurality of computing devices, and a computer program having a plurality of sub-programs executable by said computing devices, wherein the sub-programs configure said computing devices to,
receive an electronic message sent by a sender to one or more recipients,
analyze the electronic message to identify any issues in the electronic message,
fix each of the issues identified in the electronic message, said fixing resulting in a fixed version of the electronic message, and
send the fixed version of the electronic message to each of the recipients.
